(19) United States
(12) Patent Application Publication
(10) Pub. No.: US 2003/0098552 A1
(43) Pub. Date: May 29, 2003

(54) Carrier having device for assisting stair climbing

(76) Inventor: Chung Kai Hsiao, Chong Ho City (TW)

Correspondence Address: Chung Kai Hsiao, P.O. Box 10-69, Chong Ho, Taipei, 235, TW

(21) Appl. No.: 10/002,848

(22) Filed: Nov. 27, 2001

(51) Int. Cl. B62B 7/02

(52) U.S. Cl. 280/5.24; 280/47.24

(57) ABSTRACT

A carrier includes a base, a number of wheels attached to the base, and a spring biasing device for engaging with the stairs and for biasing the base while the base is moved relative to stairs, in order to facilitate the base of the carrier upstairs or downstairs. One or more posts are secured to the base, and one or more barrels are slidably engaged on the posts for engaging with the stairs. The spring biasing device includes a number of springs engaged with the barrels for for applying biasing forces against the barrels when the barrels are engaged with the stairs.

### BACKGROUND OF THE INVENTION

1. Field of the Invention

The present invention relates to a carrier, and more particularly to a carrier having a device for facilitating or assisting the carrier to climb the ladders or the stairs.

2. Description of the Prior Art

Typical carriers include a board for supporting the goods to be carried, and a number of wheels for allowing the board and goods to be transported to the other positions, and may mostly be used for carrying or transporting goods from one place to the other in horizontal or planer surfaces. The typical carriers may not be easily moved upstairs or downstairs, especially when carrying the goods therein or thereon.

The present invention has arisen to mitigate and/or obviate the afore-described disadvantages of the conventional carriers.

### SUMMARY OF THE INVENTION

The primary objective of the present invention is to provide a carrier including a device for facilitating or assisting the carrier to climb the ladders or the stairs.

In accordance with one aspect of the invention, there is provided a carrier comprising a base, a wheel device attached to the base, and means for biasing the base while the base is moved relative to stairs, in order to facilitate the base of the carrier upstairs or downstairs.

The base includes at lest one post attached thereto, and a barrel slidably engaged on the post and arranged for engaging with the stairs while climbing the stairs and when the wheels are disengaged from the stairs, the biasing means includes a spring engaged with the barrel for applying a biasing force against the barrel when the barrel is engaged with the stairs.

The base includes a beam, the post includes two ends secured to the beam, and a link secured between the beam and the post. The barrel includes a gasket received therein and engaged onto the post. The barrel includes at least one ball engaged between the gasket and the post.

A device is further provided for limiting the ball to rotate relative to the barrel and the gasket and includes two pairs of first stops secured to the ends of the barrel respectively, and at least two pairs of second stops engaged between the first stops and the ball. The first stops include a diameter greater than that of the second stops, and smaller than that of the ball.

A frame is further provided, and a device is further provided for securing the first end of the frame to the base and includes at least one lock securing the first end of the frame to the base.

The base includes a bar secured thereto, the first end of the frame includes a spindle secured thereto, the lock is engaged onto the spindle and includes two ends secured to the bar of the base.

The frame includes a casing secured thereto for carrying goods thereon. A pair of legs are attached to the frame and each including a wheel attached thereto.

A handle is further provided, and a device is further provided for adjustably securing the handle to the frame and includes a first block secured to the frame, a second block secured to the handle and rotatably secured to the first block with an axle, and means for adjustably locking the first block and the second block together.

The adjustably locking device includes a plurality of apertures formed in the first block and in the second block respectively, and a lock pin selectively engaged with the apertures of the first block and the second block for adjustably securing the first block and the second block together.

The base includes a post attached thereto and having two end portions, and two barrels slidably engaged on the end portions of the post respectively for engaging with the stairs, the biasing means includes two springs engaged with the barrels respectively for applying biasing forces against the barrels when the barrels are engaged with the stairs. One of the springs is a compression spring, and the other spring is an extension spring.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a carrier in accordance with the present invention;

FIG. 2 is an exploded view of the carrier;

FIGS. 3 and 4 are perspective views showing the angle adjusting device for the handle of the carrier;

FIG. 5 is an end view of a sliding barrel of the carrier;

FIG. 6 is a cross sectional view taken along lines 6-6 of FIG. 5;

FIGS. 7, 8, 9 are perspective views illustrating the operation of the carrier;

FIGS. 10, 11, 12 are plan views illustrating the operation of the carrier;

FIG. 13 is a perspective view illustrating the operation of the carrier:

FIG. 14 is a partial exploded view of the carrier illustrating the operation of the carrier;

FIG. 15 is a perspective view illustrating the operation of the carrier; and

FIG. 16 is a partial exploded view of the carrier as shown in FIG. 15.

### DETAILED DESCRIPTION OF THE PREFERRED EMBODIMENT

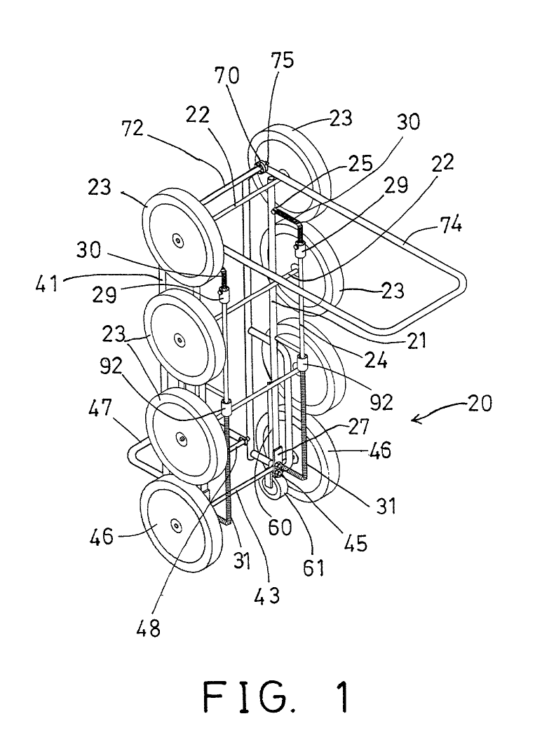

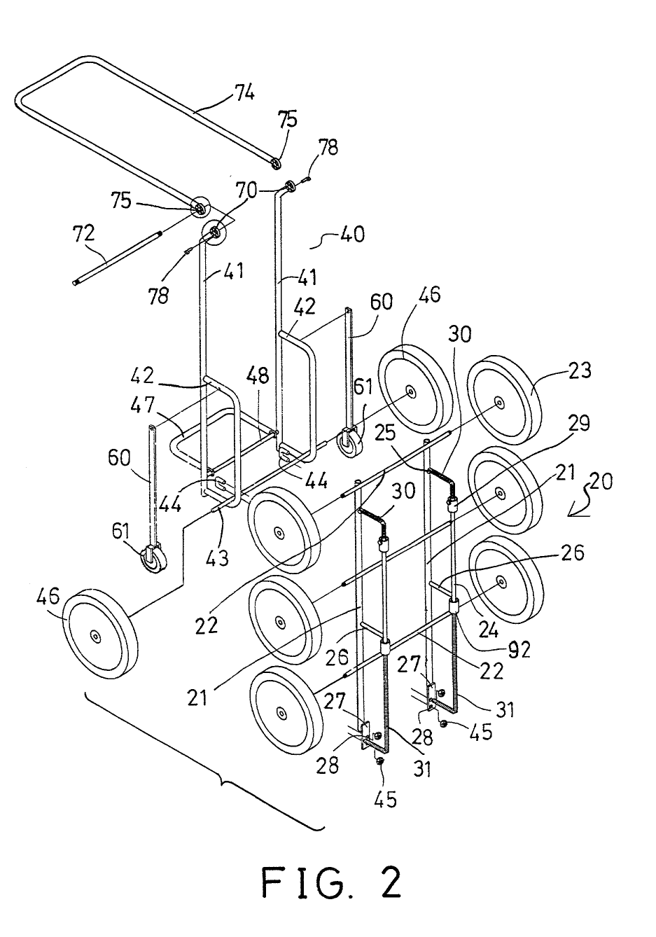

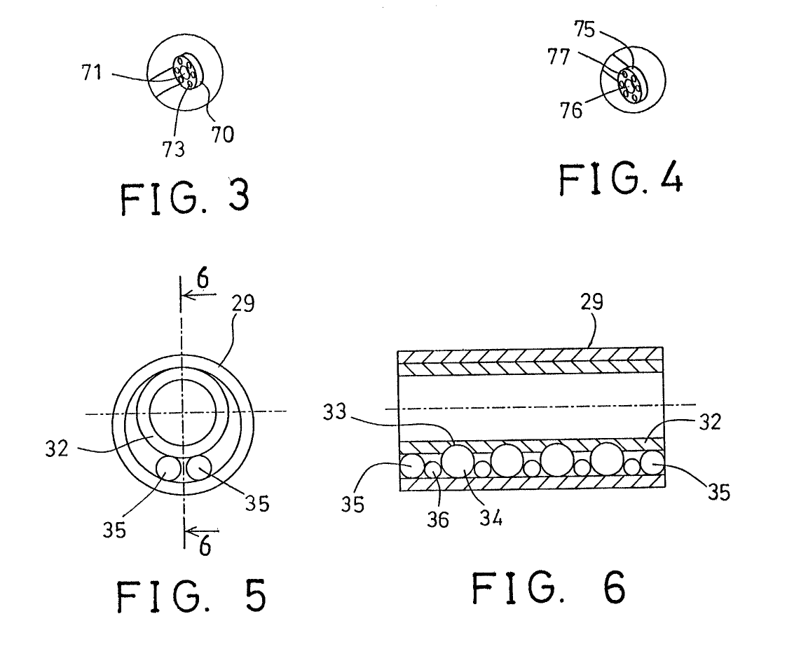

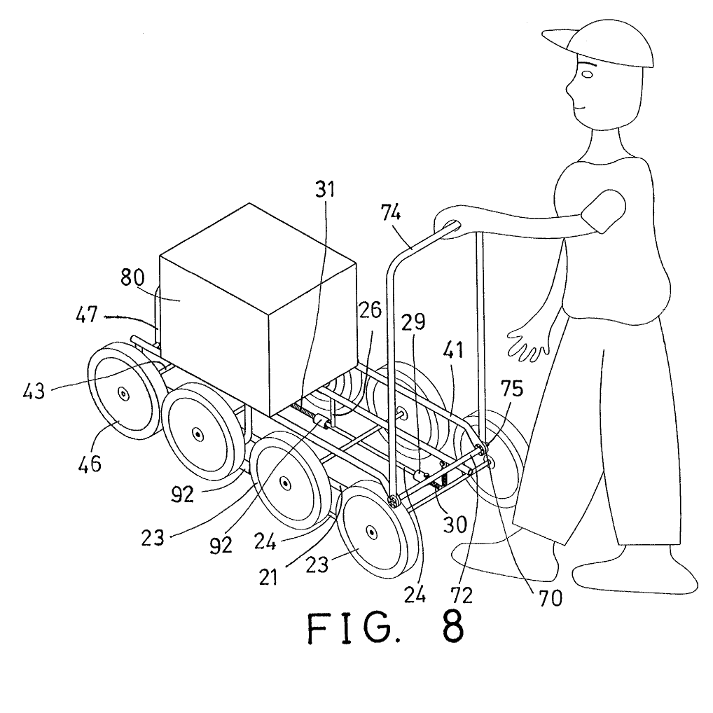

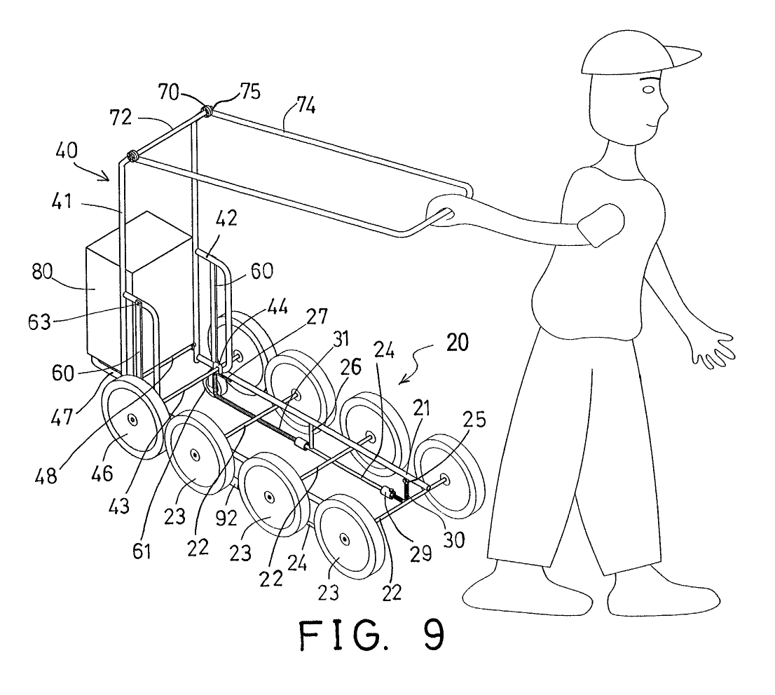

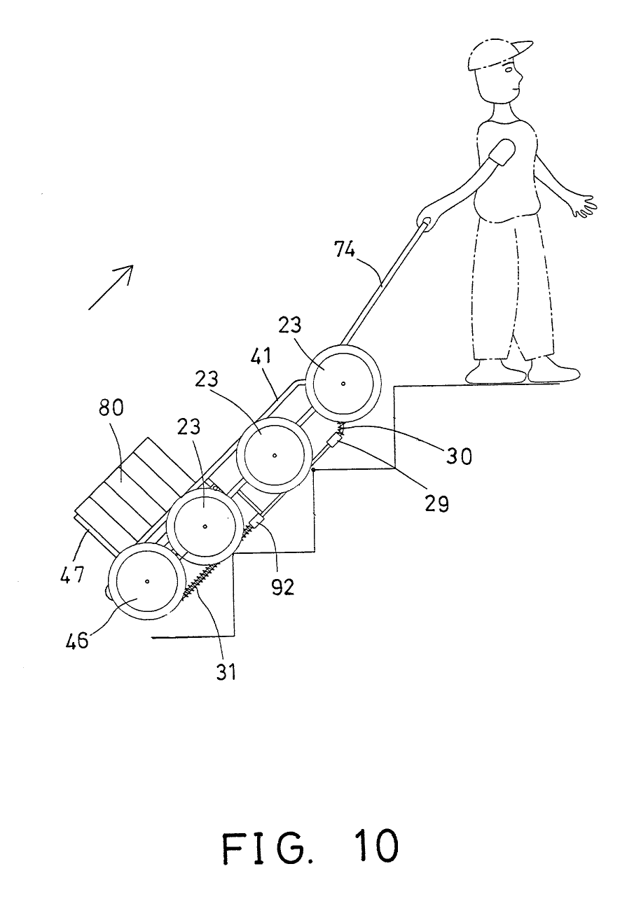

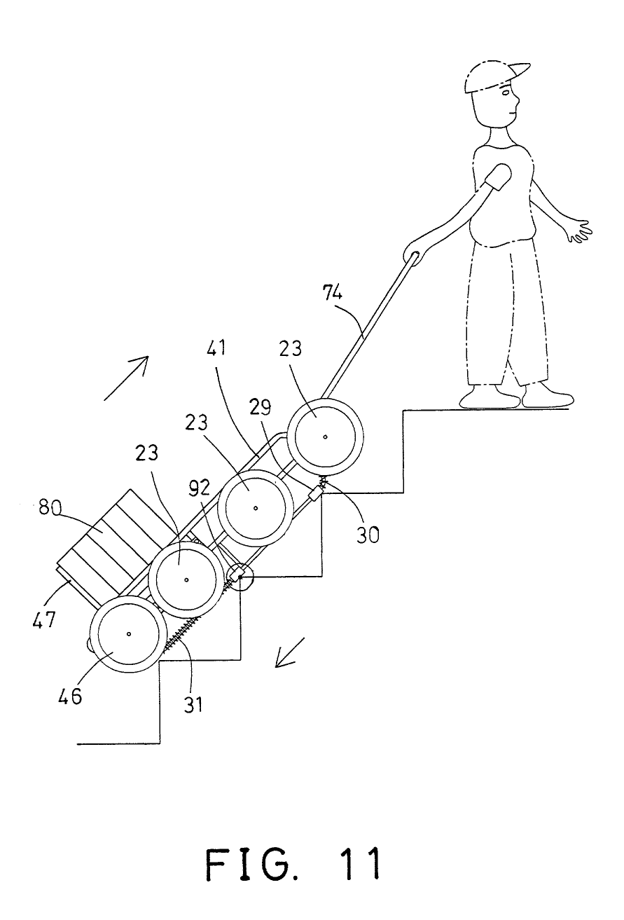

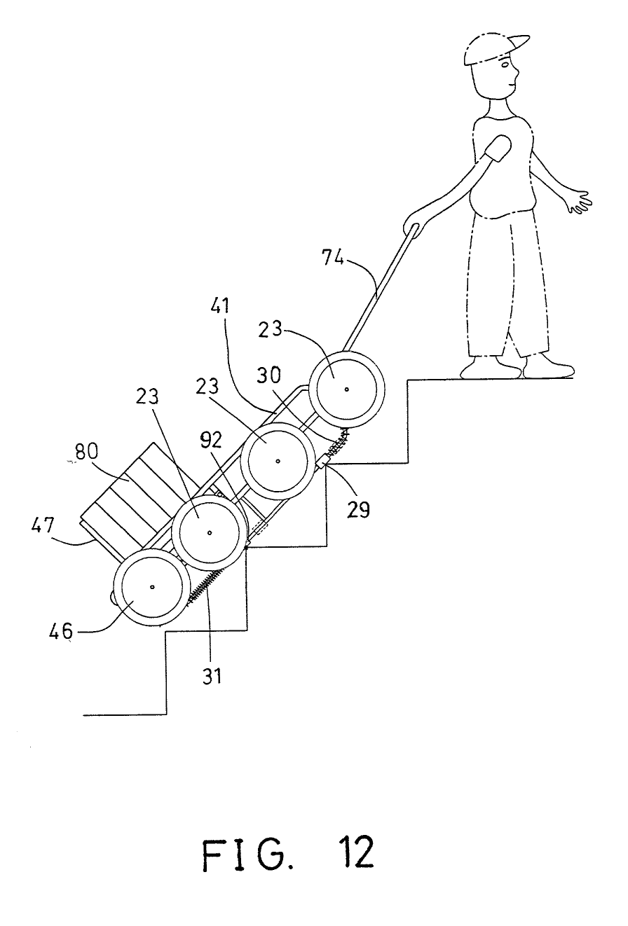

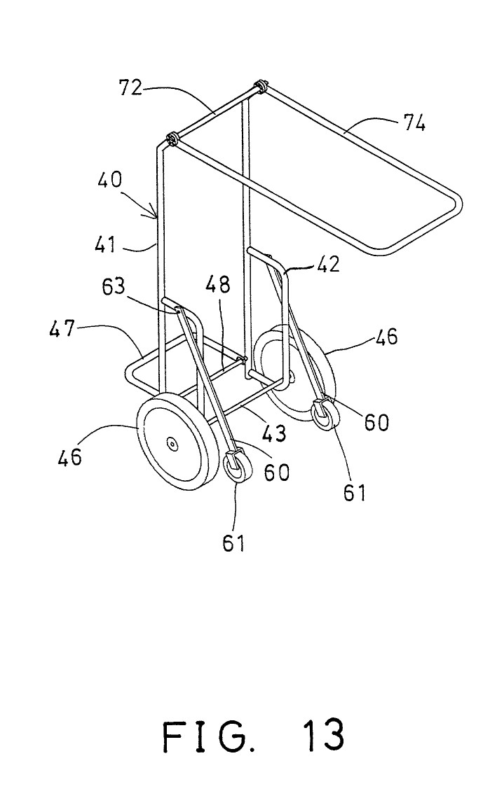

Referring to the drawings, and initially to FIGS. 1 and 2, a carrier in accordance with the present invention comprises a base 20 including a pair of longitudinal and parallel beams 21, one or more shafts 22 secured between the beams 21 for forming a substantially rectangular structure, and a wheel device 23 including two or more wheels 23 attached to the ends of the shafts 22 for engaging with the supporting surface or the ground (FIGS. 8, 9) or the stairs (FIGS. 10-12). A pair of posts 24 are arranged or disposed below the beams 21 respectively and each has two ends 25 secured to the beam 21 with fasteners, or by welding processes and each has a middle portion secured to the beam 21 with a link and by such as the welding processes. The beams 21 each includes one end having a bar 27 secured thereto and preferably parallel to the beams 21 respectively. The bars 27 each includes two or more orifices 28 formed therein.

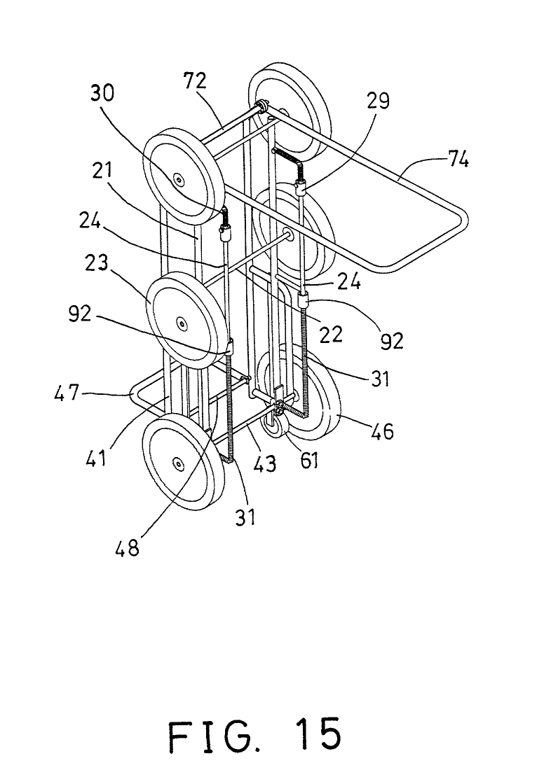

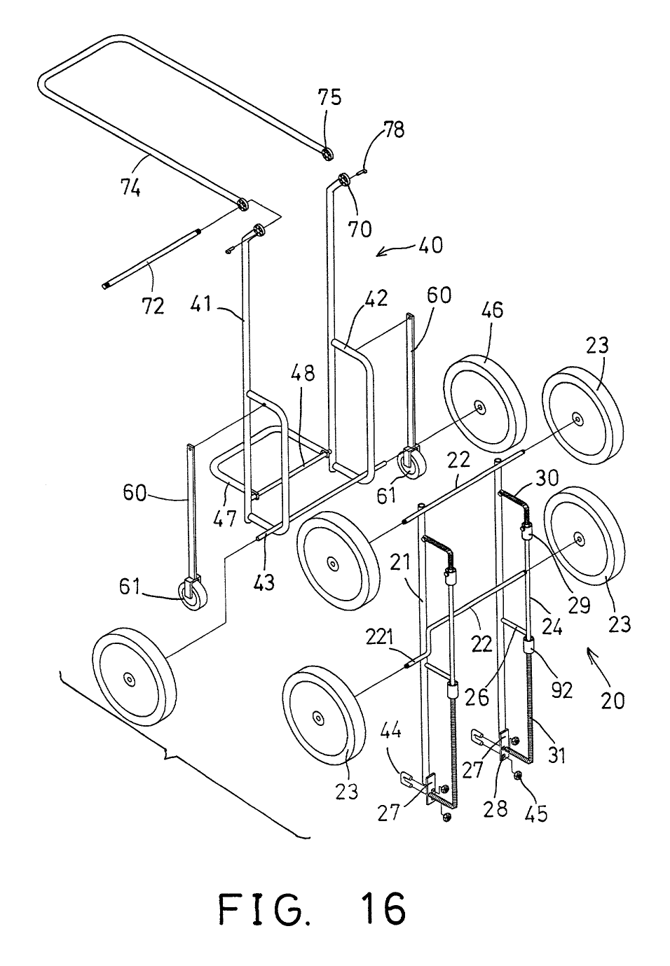

As shown in FIGS. 1, 2, and 7-12, two shafts 22 and two pairs of wheels 23 are illustrated and attached to the middle portion of the base 20. However, as shown in FIGS. 15 and 16, a single shaft 22 may be provided and attached or secured to the middle portion of the base 20 and secured between the beams 21 of the base 20. The shaft 22 includes a crank or a bent portion 221 provided on one end thereof. A wheel that is attached to one end of the shaft 22 may be located closer to one end of the base 20, and the other wheel that is attached to the other end or to the bent portion 221 of the shaft 22 may be located closer to the other end of the base 20, such that only two wheels 23 are attached to the middle portion of the base 20.

Two pairs of barrels 29 are slidably engaged on the posts 24 respectively; i.e., the posts 24 each includes two barrels 29, 92 slidably engaged thereon and separated from each other by the links 26 respectively. The links 26 may thus limit the barrels 29, 92 to slide relative to the posts 24 respectively. The barrels 29, 92 may be made of plastic, rubber, composite materials or the like, and are provided for engaging with the corners of the stairs, best shown in FIGS. 10-12. Two springs 30, such as two compression springs 30 are engaged onto one end, such as the upper ends of the posts 24 as shown in FIGS. 10-12, and engaged or secured to the barrels 29 for drawing or biasing the barrels 29 upward along the posts 24 respectively. Two further springs 31, such as two extension springs 31 are engaged onto the other end, such as the lower ends of the posts 24 as shown in FIGS. 10-12, and engaged or secured to the barrels 92 for biasing the barrels 29 upward along the posts 24 and toward the links 26 respectively.

Referring next to FIGS. 5 and 6, and again to FIGS. 1 and 2, the barrels 29, 92 each includes a gasket 32 engaged therein and slidably engaged on the posts 24 respectively, and each includes two stops 35, such as two balls 35 secured to each of the ends thereof, best shown in FIG. 5, and each includes one or more pairs of further stops 36, such as one or more pairs of balls 36 secured between the balls 35. The gasket 32 includes one or more depressions 33 formed therein. One or more balls 34 are partially engaged in the depressions 33 of the gaskets 32 and engaged between the gasket 32 and the barrel 29, 92 for allowing the gasket 32 to be slightly rotated relative to the barrel 29, 92 respectively, and for allowing the barrel 29, 92 to be slightly rotated relative to the posts 24 respectively. The balls 34 include a diameter greater than that of the stops 35 which is greater than that of the other stops 36.

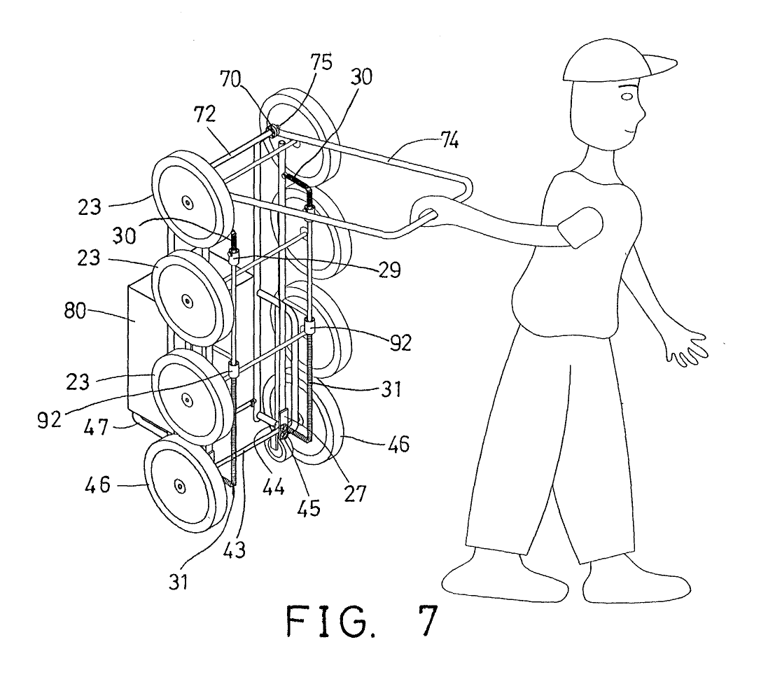

Referring next to FIGS. 7-13, and again to FIGS. 1 and 2, A frame 40 includes a pair of rods 41, a pair of brackets 42 secured on one ends of the rods 41 respectively, a spindle 43 secured between the rods 41 or the brackets 42. Two U-shaped hooks or locks 44 are engaged onto the spindle 43 and have the ends engaged through the orifices 28 of the bars 27, and secured to the bars 27 with lock nuts 45 or the like. The locks 44 may include one or more flat surfaces (not shown) or the like engaged with the corresponding flat surfaces (not shown) of the spindle 43, or may be latched or keyed to the spindle 43, for securing the spindle 43 and the frame 40 to the base 20 at the perpendicular position as shown in FIG. 9, and/or at the parallel position as shown in FIGS. 1, 7, 8 and 10-12, and/or at the other angular positions.

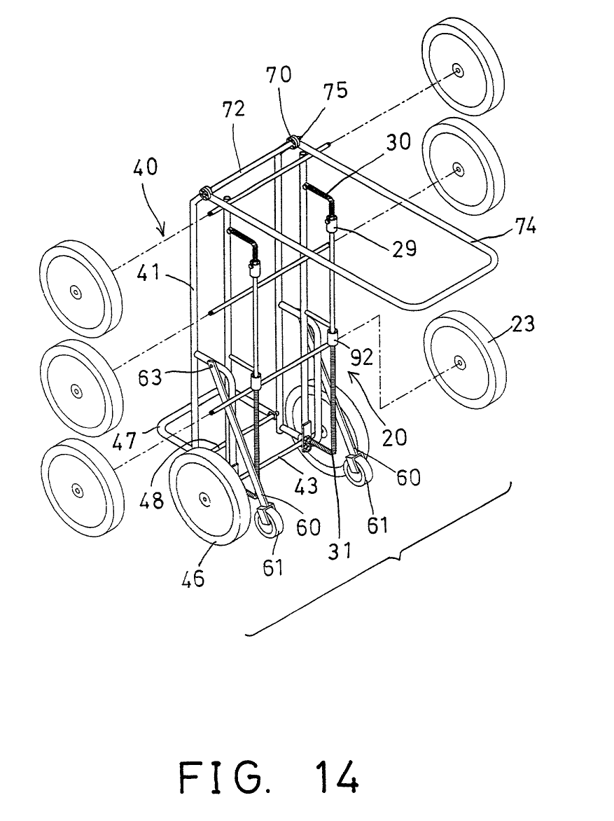

Two wheels 46 are attached to the ends of the spindle 43 for engaging with the ground whenever the base 20 is engaged with the ground (FIGS. 8, 9) or disengaged from the ground (FIGS. 1, 7). A casing 47 is secured to the rods 41. For example, the casing 47 includes a column 48 secured to the rods 41 (FIGS. 1, 2) for supporting the goods 80 or the like thereon. One or more reinforcing braces (not shown) may be secured between the frame 40 and the casing 47 for reinforcing the casing 47 and for stably supporting the goods 80 on the casing 47. A pair of legs 60 each has a wheel 61 attached to one end thereof, such as attached to the lower end thereof, and each has the other end, such as the upper end thereof rotatably or pivotally or adjustably secured to the brackets 42, for providing an auxiliary wheel device to the frame 40 and/or the base 20 (FIGS. 13, 14).

The rods 41 each includes a block 70 secured to one end thereof, and having a bore 71 formed therein for receiving an axle 72 therein, and having one or more apertures 73 formed around the bore 71 thereof. A handle 74 includes two blocks 75 secured to the ends thereof, and each having a bore 76 formed therein for receiving the axle 72 therein and for rotatably securing the handle 74 onto the axle 72, and having one or more apertures 77 formed around the bore 76 thereof. A lock pin 78 may engaged through the selected apertures 73, 77 of the blocks 70, 75 for allowing the handle 74 to be adjusted relative to the frame 40 to any selected angular position, as shown in FIGS. 7-10.

In operation, as shown in FIG. 7, the base 20 and the frame 40 may be arranged perpendicular to the ground, or may be erected for supporting the goods 80 on the casing 47. As shown in FIGS. 13 and 14, the auxiliary wheels 61 may be provided for facilitating and supporting the carrier on the erected position. As shown in FIGS. 8 and 9, the wheels 23, 46 may all be engaged with the ground for allowing the carrier to be easily moved to any places. As shown in FIG. 8, the frame 40 may be folded toward and to engage with the base 20, or may be rotated away from the base 20 as shown in FIG. 9. The goods may also be supported on the base 20.

When climbing upstairs, as shown in FIG. 10, when one or more wheels 23 are engaged with the corners of the stairs, the barrels 29, 92 are disengaged from the stairs. As shown in FIG. 11, when the upper wheels 23 are disengaged from the corners of the stairs, the barrels 29, 92 are arranged to be engaged with the corners of the stairs. At this moment, the weight of the carrier and the goods 80 may apply a force onto the barrels 29, 92 against the springs 30, 31. The compression springs 30 may thus apply a spring biasing force against the barrels 29 to pull the barrels 29 and thus the carrier and the goods 80 upward the stairs. Similarly, the extension springs 31 may also apply a spring biasing force against the barrels 92 to pull the barrels 92 and thus the carrier and the goods 80 upward the stairs. The compression springs 30 and/or the extension springs 31 may thus apply a spring biasing force against the barrels 29, 92 to offset or to resist the weight of the goods 80 and of the carrier, and to bias the barrels 29, 92 and thus the carrier and the goods 80 upward the stairs.

Similarly, while moving downstairs, the springs 30, 31 may also be used to resist the weight of the goods 80 and of the carrier, for allowing the carrier and the goods to be easily moved downstairs by the users with less force or energy.

Accordingly, the carrier in accordance with the present invention includes a device for facilitating or assisting the carrier to climb the ladders or the stairs.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A carrier comprising:
a base,
a wheel device attached to said base, and
means for biasing said base while said base is moved relative to stairs.

2. The carrier according to claim 1, wherein said base includes at lest one post attached thereto, and a barrel slidably engaged on said at least one post for engaging with the stairs, said biasing means includes a spring engaged with said barrel for applying a biasing force against said barrel when said barrel is engaged with the stairs.

3. The carrier according to claim 2, wherein said base includes a beam. said at least one post includes two ends secured to said beam, and a link secured between said beam and said at least one post.

4. The carrier according to claim 2, wherein said barrel includes a gasket received therein and engaged onto said at least one post.

5. The carrier according to claim 4, wherein said barrel includes at least one ball engaged between said gasket and said at least one post.

6. The carrier according to claim 5 further comprising means for limiting said at least one ball to rotate relative to said barrel and said gasket.

7. The carrier according to claim 6, wherein said barrel includes two ends, said limiting means includes two pairs of first stops secured to said ends of said barrel respectively, and at least two pairs of second stops engaged between said first stops and said at least one ball.

8. The carrier according to claim 7, wherein said two pairs of first stops include a diameter greater than that of said at least two pairs of second stops, and smaller than that of said at least one ball.

9. The carrier according to claim 1 further comprising a frame including a first end, and means for securing said first end of said frame to said base.

10. The carrier according to claim 9, wherein said securing means includes at least one lock securing said first end of said frame to said base.

11. The carrier according to claim 10, wherein said base includes a bar secured thereto, said first end of said frame includes a spindle secured thereto. said at least one lock is engaged onto said spindle and includes two ends secured to said bar of said base.

12. The carrier according to claim 9, wherein said frame includes a casing secured thereto for carrying goods thereon.

13. The carrier according to claim 9 further comprising a pair of legs attached to said frame and each including a wheel attached thereto.

14. The carrier according to claim 9 further comprising a handle, and means for adjustably securing said handle to said frame.

15. The carrier according to claim 14, wherein said adjustably securing means includes a first block secured to said frame, a second block secured to said handle and rotatably secured to said first block with an axle, and means for adjustably locking said first block and said second block together.

16. The carrier according to claim 15, wherein said adjustably locking means includes a plurality of apertures formed in said first block and in said second block respectively, and a lock pin selectively engaged with said apertures of said first block and said second block for adjustably securing said first block and said second block together.

17. The carrier according to claim 1, wherein said base includes a post attached thereto and having two end portions, and two barrels slidably engaged on said end portions of said post respectively for engaging with the stairs, said biasing means includes two springs engaged with said barrels respectively for applying biasing forces against said barrels when said barrels are engaged with the stairs.

18. The carrier according to claim 17, wherein a first of said springs is a compression spring, and a second of said springs is an extension spring.
